(19) United States
(12) Patent Application Publication
(10) Pub. No.: US 2010/0326998 A1
(43) Pub. Date: Dec. 30, 2010

(54) LID, LID AND CONTAINER ASSEMBLY, AND METHOD OF SECURING A LID TO A CONTAINER

(76) Inventors: Phillip R. Short, Vineland Station (CA); Xie F. Song, Shantou (CN)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 2022, BOCA RATON, FL, 33487, US

(21) Appl. No.: 12/491,111

(22) Filed: Jun. 24, 2009

(51) Int. Cl. B65D 41/16; B23P 19/04

(52) U.S. Cl. 220/780; 29/700

(57) ABSTRACT

A container and lid assembly includes a container and a lid. The container has bottom and a container sidewall extending generally upwardly from the bottom about a perimeter thereof. The container sidewall has an upper edge structure defining an inwardly inclined, inwardly facing lid engagement surface. The lid has a top and a lid sidewall depending from the top about a perimeter thereof. The lid sidewall has an upturned lower edge structure defining an outwardly extending lid shoulder and an inwardly inclined, outwardly facing container engagement surface. The lower edge structure of the lid sidewall corresponds in size and shape to the upper edge structure of the container sidewall, and the lid is securable to the container by an interference fit with the lid engagement surface engaging the container engagement surface about the respective perimeters of the container and the lid.

### FIELD OF INVENTION

The present invention relates to containers, and more particularly to lids, lid and container assemblies including such lids, and methods of using the same.

### BACKGROUND OF THE INVENTION

Containers having certain types of cooperating lids which may be secured thereto by way of a snap fit, or an interference fit, are known. Such container and lid combinations are offered, for example, under the trademark GladWare® by The Glad Products Company.

### SUMMARY OF THE INVENTION

In one aspect, the present invention is directed to a container and lid assembly. The container comprises a bottom and a container sidewall extending generally upwardly from the bottom about a perimeter thereof and having an upper edge structure defining an inwardly inclined, inwardly facing lid engagement surface. The lid, comprises a top and a lid sidewall depending from the top about a perimeter thereof and having an upturned lower edge structure defining an outwardly extending lid shoulder and an inwardly inclined, outwardly facing container engagement surface. The lower edge structure of the lid sidewall corresponds in size and shape to the upper edge structure of the container sidewall, and the lid is securable to the container by an interference fit with the lid engagement surface engaging the container engagement surface about the respective perimeters of the container and the lid.

In one embodiment, the upper edge structure of the container sidewall includes a set of opposed side portions of the upper edge structure extending parallel to one another between opposed end portions of the upper edge structure, and the lower edge structure of the lid sidewall includes a set of opposed side portions of the lower edge structure extending parallel to one another between opposed end portions of the lower edge structure.

In one embodiment, the container has a first container shoulder extending between an upper end of the container sidewall and a lower end of a container projection, an inner surface of which defines the lid engagement surface, so that when the lid is secured to the container by an interference fit between the lid engagement surface and the container engagement surface, the lid shoulder engages the first container shoulder. In such an embodiment, the container may have a peripheral second container shoulder extending outwardly from an upper end of the container projection, and the lid may have a peripheral lid flange extending outwardly from an upper end of a lid projection, an outer surface of which defines the container engagement surface, so that when the lid is secured to the container by an interference fit between the lid engagement surface and the container engagement surface, the peripheral lid flange engages the peripheral second container shoulder.

In another aspect, the present invention is directed to a lid. The lid comprises a top and a lid sidewall depending from the top about a perimeter thereof, with the lid sidewall having an upturned lower edge structure defining an outwardly extending shoulder and an inwardly inclined, outwardly facing engagement surface. The lower edge structure of the lid sidewall may include a set of opposed side portions of the lower edge structure extending parallel to one another between opposed end portions of the lower edge structure. The lid may have a peripheral lid flange extending outwardly from an upper end of a lid projection, an outer surface of which defines the container engagement surface.

In a further aspect, the present invention is directed to a method of securing a lid to a container. According to an embodiment of the method, a container as described above, and a lid as described above are provided, with the lower edge structure of the lid sidewall corresponding in size and shape to the upper edge structure of the container sidewall and the lower edge structure of the lid sidewall including a set of opposed side portions of the lower edge structure extending parallel to one another between opposed end portions of the lower edge structure. The lid and the container are positioned relative to one another so that one of the opposed end portions of the lower edge structure is disposed between the set of opposed side portions of the upper edge structure. The lid is then slid along the upper edge structure of the container until the container engagement surface on the one end portion engages the lid engagement surface on a corresponding one end portion in the set of end portions of the upper edge structure. Then the other end portion in the set of end portions of the lower edge structure and the other end portion in the set of end portions of the upper edge structure are moved relatively toward one another until the lid is secured to the container by an interference fit, with the lid engagement surface engaging the container engagement surface about the respective perimeters of the container and the lid.

In one embodiment of the method, the step of providing the container further comprises providing the container wherein the container has a first container shoulder extending between an upper end of the container sidewall and a lower end of a container projection an inner surface of which defines the lid engagement surface, and the step of sliding the lid along the upper edge structure of the container comprises sliding the lid shoulder along the first container shoulder. In this embodiment, the step of providing the container may further comprise providing the container wherein the container has a peripheral second container shoulder extending outwardly from an upper end of the container projection, and the step of providing the lid may further comprises providing the lid wherein the lid has a peripheral lid flange extending outwardly from an upper end of a lid projection an outer surface of which defines the container engagement surface, in which case the step of sliding the lid along the upper edge structure of the container may comprise sliding the peripheral lid flange along the peripheral second container shoulder.

### BRIEF DESCRIPTION OF THE DRAWINGS

These and other features of the invention will become more apparent from the following description in which reference is made to the appended drawings wherein:

FIG. 1 is a perspective view of an exemplary container, according to an aspect of the present invention;

FIG. 2 is a perspective view of an exemplary lid, according to an aspect of the present invention;

FIG. 3A shows a cross section of the container of FIG. 1, taken along the line 3-3 in FIG. 1 and a cross section of the lid of FIG. 2, taken along the line 3-3 in FIG. 2, the container and the lid being disengaged from one another;

FIG. 3B shows a cross section of the container of FIG. 1, taken along the line 3-3 in FIG. 1 and a cross section of the lid of FIG. 2, taken along the line 3-3 in FIG. 2, the container and the lid being engaged with one another;

FIG. 4 shows the lid of FIG. 1 having been positioned so that one of the opposed end portions of the lower edge structure of the lid is disposed between the set of opposed side portions of the upper edge structure of the container of FIG. 1;

FIG. 5 shows the lid of FIG. 1 having been slid along the upper edge structure of the container of FIG. 1 from the position shown in FIG. 4;

FIG. 6 shows the lid of FIG. 1 in a position where the container engagement surface on the forward end portion of the lid has engaged the lid engagement surface on the corresponding end portion of the container of FIG. 1;

FIG. 7 shows the lid of FIG. 1 and the container of FIG. 1 having been secured to one another;

FIG. 8A is a top view dimension drawing of an exemplary container, according to an aspect of the present invention;

FIG. 8B is a side view dimension drawing of the container of FIG. 8A;

FIG. 8C is an end view dimension drawing of the container of FIG. 8A;

FIG. 9A is a top view dimension drawing of one exemplary embodiment of a lid, according to an aspect of the present invention;

FIG. 9B is a side view dimension drawing of the lid of FIG. 9A;

FIG. 10A is a top view dimension drawing of another exemplary embodiment of a lid, according to an aspect of the present invention; and

FIG. 10B is a side view dimension drawing of the lid of FIG. 10A.

### DETAILED DESCRIPTION

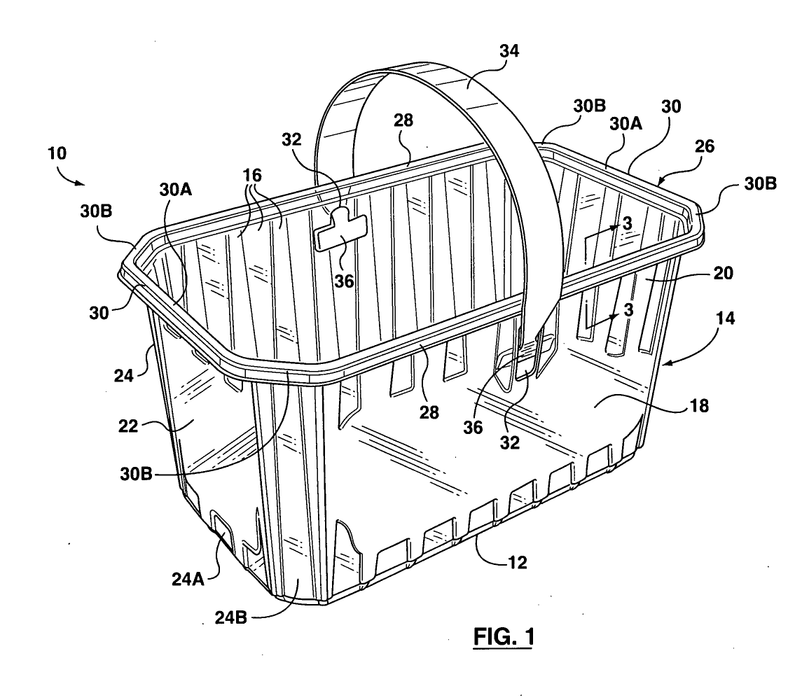

With reference now to FIG. 1, an exemplary container is shown generally at 10. As will be described in greater detail below, the container may form part of a container and lid assembly. The container 10 comprises a bottom 12 and a container sidewall 14 extending generally upwardly from the bottom 12 about a perimeter thereof. In the illustrated embodiment, the container sidewall 14 is crenated by alternating outwardly and inwardly impressed trapezoidal regions to define a plurality of trapezoidal strengthening ribs 16. The strengthening ribs 16 are omitted from a smooth region 18 on a side portion 20 of the container sidewall 14 and a smooth region 22 on an end portion 24 of the container sidewall. These smooth regions 18 and 22 may provide a substrate for an adhesive label, or for direct application of paint. The end portions 24 of the container sidewall 14 are defined by main end portions 24A and corner portions 24B extending diagonally between the side portions 20 and the main end portions 24A of the container sidewall 14.

The container sidewall 14 has an upper edge structure 26, which includes a set of opposed side portions 28 extending parallel to one another between opposed end portions 30 of the upper edge structure 26. The opposed side portions 28 on the upper edge structure 26 define the terminus of the side portions 20 of the container sidewall 14, and the opposed end portions 30 of the upper edge structure 26 define the termini of the end portions 24 of the container sidewall. In the illustrated embodiment, the upper edge structure 26 of the container sidewall 14 has an elongated octagonal shape, with the two longest sides of the octagon being opposed to one another to define the opposed side portions 28 of the upper edge structure 26. The opposed end portions 30 of the upper edge structure 26 are each defined by the portions 30A, 30B of the upper edge structure 26 corresponding, respectively, to the main end portions 24A and corner portions 24B of the container sidewall 14.

Opposed receiving slots 32 are defined in the side portions 20 of the container sidewall 14 for receiving a handle 34. The handle 34 has T-shaped end portions 36 for retaining the handle 34 in the receiving slots 32.

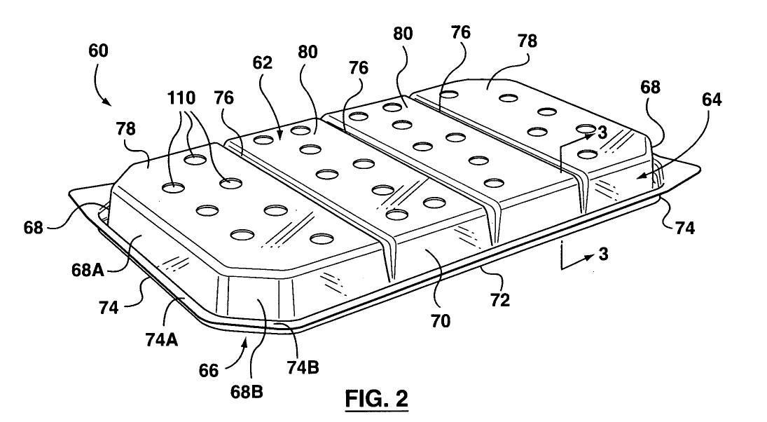

Referring now to FIG. 2, a first exemplary lid is shown generally at 60. As will be described in greater detail below, the lid 60 is securable to the container 10 by an interference fit so as to cover the container 10. The lid 60 comprises a top 62 and a lid sidewall 64 depending from the top 62 about a perimeter thereof and terminating in an upturned lower edge structure 66 corresponding in size and shape to the upper edge structure 26 of the container sidewall 64. Analogously to the container 10, the lower edge structure 66 of the lid sidewall 64 has an elongated octagonal shape corresponding to the elongated octagonal shape of the upper edge structure 26 of the container sidewall 14, and the lid sidewall 64 has opposed end portions 68 defined by main end portions 68A and corner portions 68B extending diagonally between the main end portions 68A and the opposed side portions 70. The lower edge structure 66 of the lid sidewall includes a set of opposed side portions 72 formed by the two longest sides of the octagon, which extend parallel to one another between opposed end portions 74 of the lower edge structure 66. Similarly to the container 10, the opposed end portions 74 of the lower edge structure 66 are each defined by the portions 74A, 74B of the lower edge structure 66 corresponding, respectively, to the main end portions 68A and corner portions 68B of the lid sidewall 64.

The lid 60, while integrally formed from a single piece of material, comprises a plurality of sections defined by a series of transverse channels 76 extending across the top 62 and a portion of the lid sidewall 64. In particular, in the exemplary embodiment shown in FIG. 2 the lid 60 comprises two end sections 78 and two intermediate sections 80 disposed between the end sections 78. The end sections 78 of the lid 60 encompass the main end portions 68A and corner portions 68B of the sidewall as well as part of the opposed side portions 70 thereof, including the associated portions of the lower edge structure 66 and the corresponding portions of the top 62. The intermediate sections 80 of the lid 60 encompass portions of the opposed side portions 70 and the associated portions of the lower edge structure 66 and of the top 62.

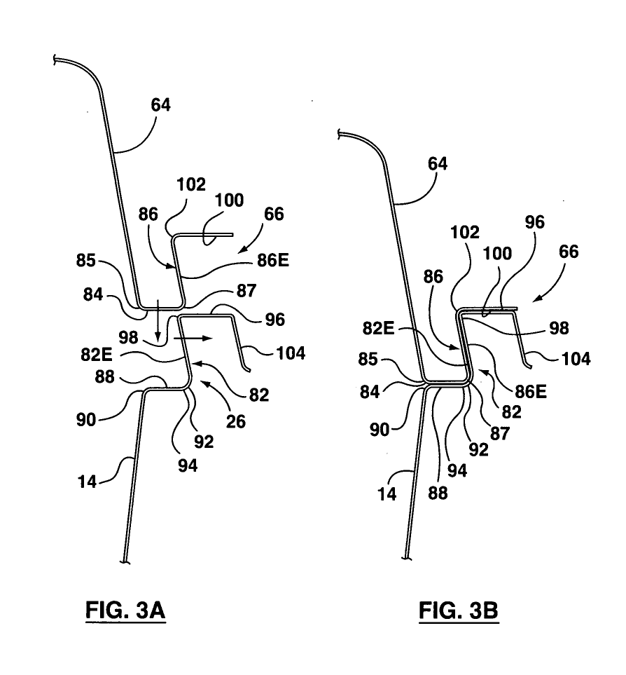

Reference is now made to FIG. 3A. The upper edge structure 26 of the container sidewall 14 includes a container projection 82 whose inner surface defines an inwardly inclined, inwardly facing lid engagement surface 82E, and the upturned lower edge structure 66 of the lid sidewall 64 defines a lid shoulder 84 extending outwardly from the lower end 85 of the lid sidewall 64 and a lid projection 86 whose exterior surface defines an inwardly inclined, outwardly facing container engagement surface 86E. The lid projection 86 which defines the container engagement surface 86E projects at an upward, inward incline from the outer edge 87 of the lid shoulder 84. As can be seen in FIG. 3B, the lid 60 is securable to the container 10 by an interference fit, with the lid engagement surface 82E engaging the container engagement surface 86E about the respective perimeters of the container 10 and the lid 60.

Referring again to FIG. 3A, it can be seen that the container 10 has a first container shoulder 88 extending between the upper end 90 of the container sidewall 14 and the lower end 92 of the container projection 82 that defines the lid engagement surface 82E. Thus, the first container shoulder 88 extends outwardly from the upper end 90 of the container sidewall 14, and the container projection 82 projects at an upward, inward incline from the outer edge 94 of the first container shoulder 88. When the lid 60 is secured to the container 10 by an interference fit between the lid engagement surface 82 and the container engagement surface 86, as shown in FIG. 3B, the lower surface of the lid shoulder 84 engages the upper surface of the first container shoulder 88.

Referring once again to FIG. 3A, the upper edge structure 26 of the container 10 defines a peripheral second container shoulder 96 extending outwardly from the upper end 98 of the container projection 82, and the lower edge structure 66 of the lid 60 defines a peripheral lid flange 100 extending outwardly from the upper end 102 of the lid projection 86 that defines the container engagement surface 86. As shown in FIG. 3B, when the lid 60 is secured to the container 10 by an interference fit between the lid engagement surface 82E and the container engagement surface 86E, the lower surface of the peripheral lid flange 100 engages the upper surface of the peripheral second container shoulder 96. A peripheral skirt 104 depends downwardly from the peripheral second container shoulder 96 at an outward incline.

As shown in FIGS. 3A and 3B, the transition between the lid shoulder 84 and the lid projection 86, and the transition between the first container shoulder 88 and the container projection 82, are preferably rounded to facilitate the interference fit.

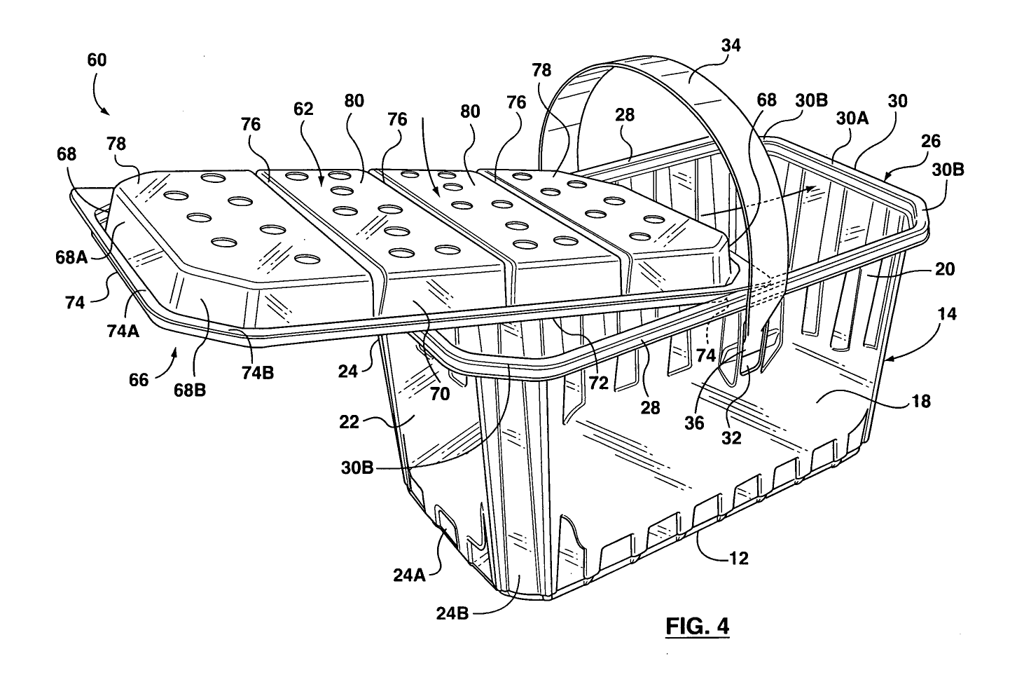

With reference now to FIGS. 4 to 6, a method of securing a lid, such as the exemplary lid 60 taught herein, to a compatible container, such as the container 10 taught herein, is now described. According to this method, a suitable lid (such as the exemplary lid 60) and a suitable container (such as the exemplary container 10) are provided. Typically, the container 60 will contain contents to be stored or transported, such as fresh produce.

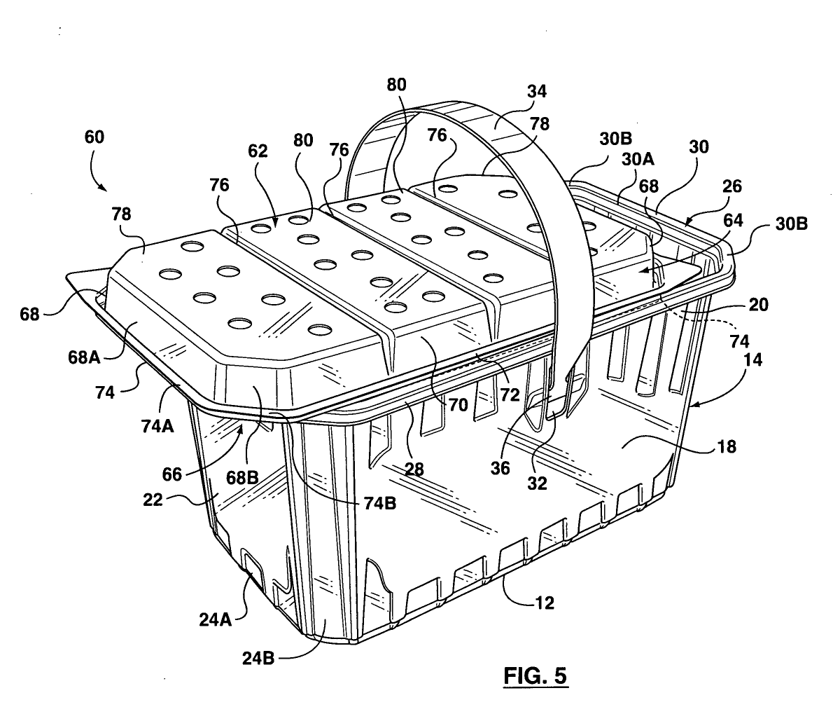

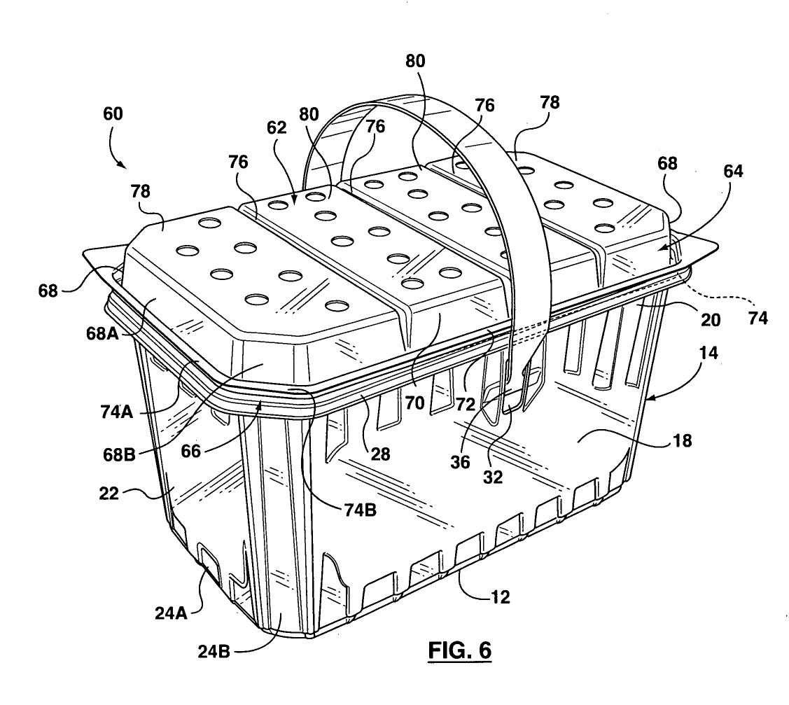

Once the container 10 and lid 60 have been provided (which can be done in any order), the next step in the method is to position the lid 60 relative to the container 10 so that one of the opposed end portions 74 of the lower edge structure 66 is disposed between the set of opposed side portions 28 of the upper edge structure 26 as shown in FIG. 4. After the lid 60 has been so positioned, the next step is to slide the lid 60 along the upper edge structure 26 of the container 10, as shown in FIG. 5, until the container engagement surface 86E (FIGS. 3A and 3B) on the forward end portion 74 (i.e. “forward” relative to the direction of sliding) engages the lid engagement surface 82E (FIGS. 3A and 3B) on the corresponding end portion 30 of the upper edge structure 26, as shown in FIG. 6. In a preferred implementation of the method, at the forwardmost parts of the lower edge structure 66 (relative to the direction of sliding) the lid shoulder 84 (FIGS. 3A and 3B) slides along the first container shoulder 88 (FIGS. 3A and 3B) and the lid flange 100 slides along the second container shoulder 96, while the second container shoulder 96 at the portions 30B of the upper edge structure 26 corresponding to the corner portions 24B of the container sidewall 14 supports the lid shoulder 84 on the opposed side portions 70 of the lower edge structure 66 as the lid 60 slides.

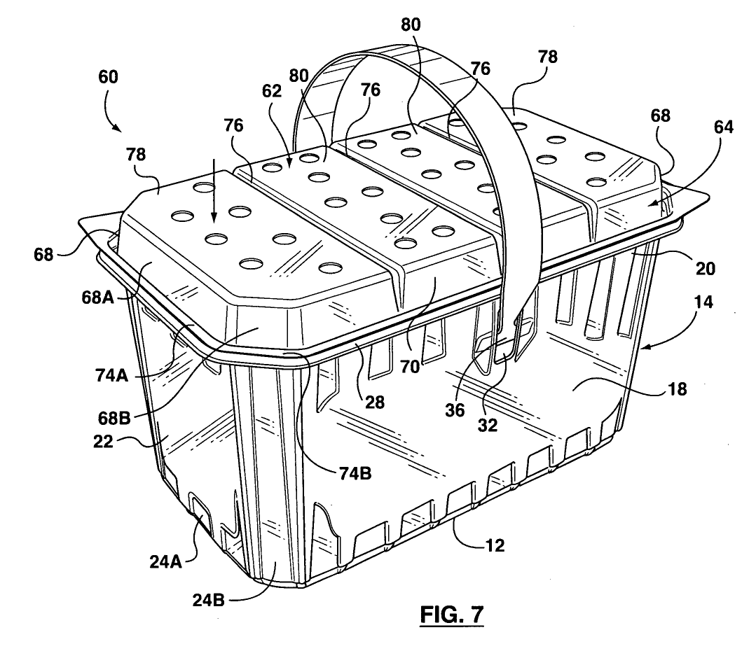

Once the sliding is complete and the container engagement surface 86E (FIGS. 3A and 3B) on the forward end portion 74 engages the lid engagement surface 82E (FIGS. 3A and 3B) on the corresponding end portion 30 of the upper edge structure 26 (see FIG. 6), the final step in the method is to move the other end portion 74 of the lower edge structure 66 and the other end portion 26 of the upper edge structure together until the lid 60 is secured to the container 10 by an interference fit, with the lid engagement surface 82E (FIGS. 3A and 3B) engaging the container engagement surface 86E (FIGS. 3A and 3B) about the respective perimeters of the container 10 and the lid 60, as shown in FIG. 7.

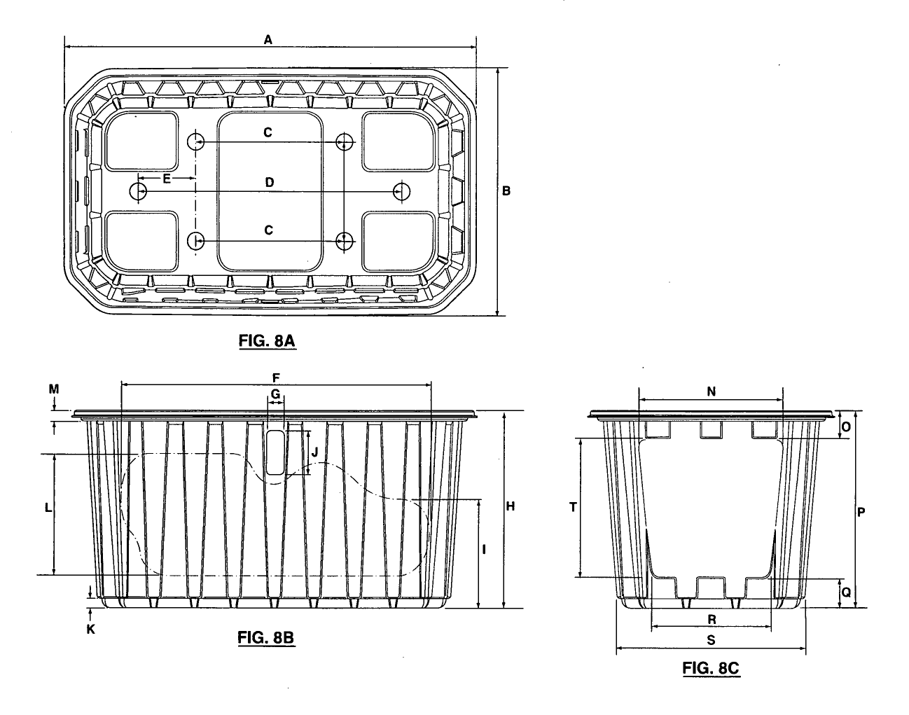

The container 10 and lid 60 may be made from any suitable resilient plastic of suitable rigidity and, where food is to be placed in the container 10, the container 10 and lid 60 should be made from a food-grade plastic. Where fresh produce is to be placed in the container 10, a plurality of apertures (see FIG. 8A) are defined in the bottom 12, and a plurality of apertures 110 are defined in the lid 60, to permit the produce to “breathe”. Containers according to aspects of the present invention may be made from polypropylene (PP), and lids according to aspects of the present invention may be made from polyethylene terephthalate (PET). Containers and lids according to aspects of the present invention may be transparent, translucent, or opaque.

Reference is now made to FIGS. 8A, 8B and 8C, which are dimension drawings for an embodiment of a container according to an aspect of the present invention. In FIGS. 8A, 8B and 8C, reference letters have been used to denote various dimensions. The chart below sets out the corresponding approximate numerical dimensions of a currently preferred embodiment of a container according to aspects of the present invention, in millimeters. It will be appreciated that the dimensions set out in the table below represent the mold dimensions, and hence are representative of a container molded perfectly, without shrinkage. As such, where containers are made from polypropylene, shrinkage following molding may cause the exact dimensions to be slightly different from those set out in the table below.

| Reference | Dimension (mm) |
|---|---|
| A | 233.00 |
| B | 140.00 |
| C | 84.00 |
| D | 149.00 |
| E | 32.50 |
| F | 173.00 |
| G | 10.00 |
| H | 110.00 |
| I | 43.00 |
| J | 23.90 |
| K | 6.00 |
| L | 68.70 |
| M | 5.20 |
| N | 79.00 |
| O | 15.00 |
| P | 109.00 |
| Q | 17.00 |
| R | 66.00 |
| S | 106.50 |
| T | 77.00 |

A container manufactured according to the dimensions in the above table will have a volume of approximately 3 liters, not including additional volume provided by the lid.

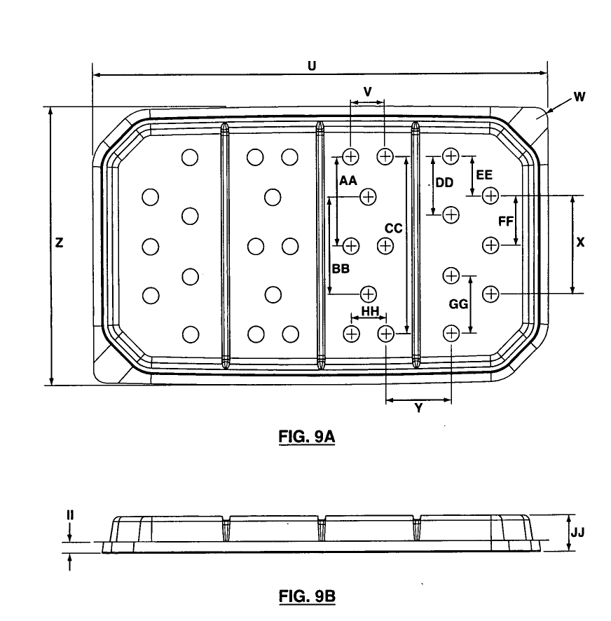

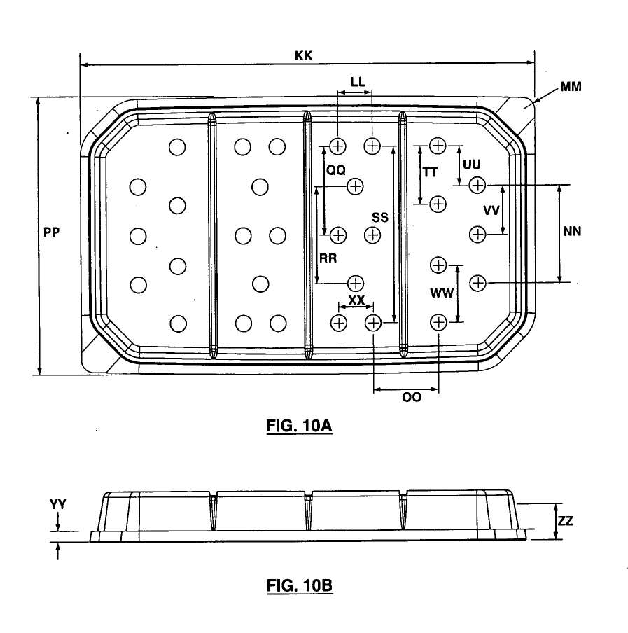

Lids according to aspects of the present invention may be made with a number of different sidewall heights. FIGS. 9A and 9B, and FIGS. 10A and 10B show, respectively, different embodiments of exemplary lids according to aspects of the present invention.

Reference is first made to FIGS. 9A and 9B, which are dimension drawings for an embodiment of a lid according to an aspect of the present invention. In FIGS. 9A and 9B, reference letters have been used to denote various dimensions. The chart below sets out the corresponding approximate numerical dimensions of one currently preferred embodiment of a lid according to aspects of the present invention, in millimeters. It will be appreciated that the dimensions set out in the table below represent the mold dimensions, and hence are representative of a container molded perfectly, without shrinkage. As such, where containers are made from polyethylene terephthalate, shrinkage following molding may cause the exact dimensions to be slightly different from those set out in the table below.

| Reference | Dimension (mm) |
|---|---|
| U | 229.00 |
| V | 17.40 |
| W | 6.00 (Radius) |
| X | 48.55 |
| Y | 32.95 |
| Z | 137.37 |
| AA | 43.68 |
| BB | 47.98 |
| CC | 87.35 |
| DD | 28.68 |
| EE | 19.41 |
| FF | 24.27 |
| GG | 28.68 |
| HH | 17.40 |
| II | 5.40 |
| JJ | 18.00 |

Reference is now made to FIGS. 10A and 10B, which are dimension drawings for another embodiment of a lid according to an aspect of the present invention. The embodiment shown in FIGS. 10A and 10B has higher sidewalls than the embodiment shown in FIGS. 9A and 9B. In FIGS. 10A and 10B, reference letters have been used to denote various dimensions. The chart below sets out the corresponding approximate numerical dimensions of one currently preferred embodiment of a lid according to aspects of the present invention, in millimeters. It will be appreciated that the dimensions set out in the table below represent the mold dimensions, and hence are representative of a container molded perfectly, without shrinkage. As such, where containers are made from polyethylene terephthalate, shrinkage following molding may cause the exact dimensions to be slightly different from those set out in the table below.

| Reference | Dimension (mm) |
|---|---|
| KK | 229.00 |
| LL | 17.40 |
| MM | 6.00 (Radius) |
| NN | 48.55 |
| OO | 32.95 |
| PP | 137.37 |
| QQ | 43.68 |
| RR | 47.98 |
| SS | 87.35 |
| TT | 28.68 |
| UU | 19.41 |
| VV | 24.27 |
| WW | 28.68 |
| XX | 17.40 |
| YY | 5.50 |
| ZZ | 25.00 |

One or more currently preferred embodiments have been described by way of example, and numerous other embodiments may be constructed and used without departing from the scope of the present invention. For example, instead of being defined by main end portions 24A and corner portions 24B, the end portions 24 of the container sidewall 14 (and hence the end portions 30 of the upper edge structure 26) may be rounded or curved, with the end portions 68 of the lid sidewall 64 (and hence the end portions 74 of the lower edge structure 66) being correspondingly rounded or curved rather than being defined by main end portions 68A and corner portions 68B. It will be apparent to persons skilled in the art that a number of other variations and modifications can be made without departing from the scope of the invention as defined in the claims.

What is claimed is:

1. A container and lid assembly, comprising:
a container, comprising:
a bottom;
a container sidewall extending generally upwardly from the bottom about a perimeter thereof;
the container sidewall having an upper edge structure defining an inwardly inclined, inwardly facing lid engagement surface; and
a lid, comprising:
a top;
a lid sidewall depending from the top about a perimeter thereof;
the lid sidewall having an upturned lower edge structure defining an outwardly extending lid shoulder and an inwardly inclined, outwardly facing container engagement surface, the lower edge structure of the lid sidewall corresponding in size and shape to the upper edge structure of the container sidewall;
the lid securable to the container by an interference fit with the lid engagement surface engaging the container engagement surface about the respective perimeters of the container and the lid.

2. The container and lid assembly of claim 1, wherein:
the upper edge structure of the container sidewall includes a set of opposed side portions of the upper edge structure extending parallel to one another between opposed end portions of the upper edge structure; and
the lower edge structure of the lid sidewall includes a set of opposed side portions of the lower edge structure extending parallel to one another between opposed end portions of the lower edge structure.

3. The container and lid assembly of claim 1, wherein:
the container has a first container shoulder extending between an upper end of the container sidewall and a lower end of a container projection an inner surface of which defines the lid engagement surface;
so that when the lid is secured to the container by an interference fit between the lid engagement surface and the container engagement surface, the lid shoulder engages the first container shoulder.

4. The container and lid assembly of claim 3, wherein:
the container has a peripheral second container shoulder extending outwardly from an upper end of the container projection; and
the lid has a peripheral lid flange extending outwardly from an upper end of a lid projection an outer surface of which defines the container engagement surface;
so that when the lid is secured to the container by an interference fit between the lid engagement surface and the container engagement surface, the peripheral lid flange engages the peripheral second container shoulder.

5. A lid, comprising:
a top;
a lid sidewall depending from the top about a perimeter thereof;
the lid sidewall having an upturned lower edge structure defining an outwardly extending shoulder and an inwardly inclined, outwardly facing engagement surface.

6. The lid of claim 5, wherein the lower edge structure of the lid sidewall includes a set of opposed side portions of the lower edge structure extending parallel to one another between opposed end portions of the lower edge structure.

7. The lid of claim 5, wherein the lid has a peripheral lid flange extending outwardly from an upper end of a lid projection an outer surface of which defines the container engagement surface.

8. A method of securing a lid to a container, comprising the steps of:
providing a container comprising:
a bottom;
a container sidewall extending generally upwardly from the bottom about a perimeter thereof;
the container sidewall having an upper edge structure defining an inwardly inclined, inwardly facing lid engagement surface;
wherein the upper edge structure of the container sidewall includes a set of opposed side portions of the upper edge structure extending parallel to one another between opposed end portions of the upper edge structure;
providing a lid, comprising:
a top;
a lid sidewall depending from the top about a perimeter thereof;
the lid sidewall having an upturned lower edge structure defining an outwardly extending lid shoulder and an inwardly inclined, outwardly facing container engagement surface, the lower edge structure of the lid sidewall corresponding in size and shape to the upper edge structure of the container sidewall;
wherein the lower edge structure of the lid sidewall includes a set of opposed side portions of the lower edge structure extending parallel to one another between opposed end portions of the lower edge structure;
positioning the lid and the container relative to one another so that one of the opposed end portions of the lower edge structure is disposed between the set of opposed side portions of the upper edge structure;
sliding the lid along the upper edge structure of the container until the container engagement surface on the one end portion engages the lid engagement surface on a corresponding one end portion in the set of end portions of the upper edge structure; and
moving the other end portion in the set of end portions of the lower edge structure and the other end portion in the set of end portions of the upper edge structure together until the lid is secured to the container by an interference fit with the lid engagement surface engaging the container engagement surface about the respective perimeters of the container and the lid.

9. The method of claim 8, wherein:
the step of providing the container further comprises providing the container wherein the container has a first container shoulder extending between an upper end of the container sidewall and a lower end of a container projection an inner surface of which defines the lid engagement surface; and
the step of sliding the lid along the upper edge structure of the container comprises sliding the lid shoulder along the first container shoulder.

10. The method of claim 9, wherein:
the step of providing the container further comprises providing the container wherein the container has a peripheral second container shoulder extending outwardly from an upper end of the container projection;
the step of providing the lid further comprises providing the lid wherein the lid has a peripheral lid flange extending outwardly from an upper end of a lid projection an outer surface of which defines the container engagement surface; and
the step of sliding the lid along the upper edge structure of the container comprises sliding the peripheral lid flange along the peripheral second container shoulder.
